(19) United States
(12) Patent Application Publication
(10) Pub. No.: US 2014/0297011 A1
(43) Pub. Date: Oct. 2, 2014

(54) AUDIO BROADCASTING METHOD AND ELECTRONIC DEVICE USING THE SAME

(71) Applicant: WISTRON CORPORATION, New Taipei City (TW)

(72) Inventor: Hsi-Wun Hsu, New Taipei City (TW)

(73) Assignee: Wistron Corporation, New Taipei City (TW)

(21) Appl. No.: 13/867,144

(22) Filed: Apr. 22, 2013

(30) Foreign Application Priority Data
Mar. 27, 2013 (TW) 102110888

(51) Int. Cl. G06F 1/32

(52) U.S. Cl. CPC G06F 1/3203
USPC 700/94

(57) ABSTRACT

An audio broadcasting method and an electronic device using the same are provided. The audio broadcasting method includes the following steps. Under a power saving mode or a power off mode, a power is provided to an audio codec. Under the power saving mode or the power off mode, an audio signal is received and processed by the audio codec. Under the power saving mode or the power off mode, the processed audio signal is outputted by a speaker.

This application claims the benefit of Taiwan application Serial No. 102110888, filed Mar. 27, 2013, the subject matter of which is incorporated herein by reference.

### BACKGROUND

1. Technical Field

The disclosure relates in general to an audio broadcasting method and an electronic device using the same, and more particularly to an audio broadcasting method performed under a power saving mode or a power off mode and an electronic device using the same.

2. Description of the Related Art

Accompanying advancements in technologies, various electronic products are constantly progressing. Notebook computer and tablet computer having advantages of convenience for carrying and well performance have been used in public.

Expect for the computer, some user carry a portable media player. Generally speaking, the performance of the sound effect of the computer is better than that of the portable media player.

Some user will connect the portable media player to the computer for obtaining a better performance on the sound effect. However, the computer must be under a power on mode and consumes a lot of power.

### SUMMARY

The disclosure is directed to an audio broadcasting method and an electronic device using the same. A power is provided to an audio codec under a power saving or a power off mode, such that the electronic device can broadcast an audio signal under the power saving or the power off mode.

According to a first aspect of the present disclosure, an audio broadcasting method is provided. The audio broadcasting method includes the following steps. Under a power saving mode or a power off mode, a power is provided to an audio codec. Under the power saving mode or the power off mode, an audio signal is received and processed by the audio codec. Under the power saving mode or the power off mode, the processed audio signal is outputted by a speaker.

According to a second aspect of the present disclosure, an electronic device is provided. The electronic device includes a power supply system, an audio codec and a speaker. A power is provided to the audio codec and the audio codec receives and processes an audio signal under a power saving mode or a power off mode. The speaker is for outputting the processed audio signal under the power saving mode or the power off mode.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows an electronic device;

FIG. 2 shows a flowchart of an audio broadcasting method; and

FIG. 3 shows a BIOS setup menu.

### DETAILED DESCRIPTION

Preferred embodiments are disclosed below for elaborating the invention. A power is provided to an audio codec under a power saving or a power off mode, such that the electronic device can broadcast an audio signal under the power saving or the power off mode. However, the following embodiments are for the purpose of elaboration only, not for limiting the scope of protection of the invention. Besides, secondary elements are omitted in the following embodiments to highlight the technical features of the invention.

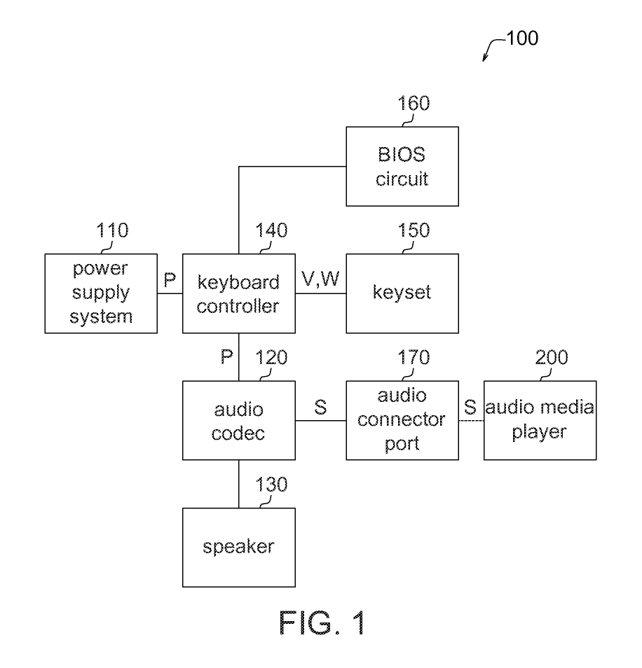

Please referring to FIG. 1, an electronic device 100 is shown. For example, the electronic device 100 can be a notebook computer, a personal computer, a smart phone or an intelligent home appliance having an operating system (OS). The operating system provides an operation interface for user to perform several functions of the electronic device 100.

The electronic device 100 includes a power supply system 110, an audio codec 120, a speaker 130, a keyboard controller (KBC) 140, a key set 150, a basic input/output system (BIOS) circuit 160 and an audio connector port 170. The power supply system 110 is used for providing a power P. For example, the power supply system 110 can be composed of a battery, a power supply line and a voltage regulator circuit. The audio codec 120 is used for processing an audio signal S. The audio codec 120 can be composed of an analog-to-digital converter, a digital-to-analog converter and a filter. The speaker 130 is used for broadcasting the audio signal S. The speaker 130 can be a horn or an earphone.

The keyboard controller 140 is used for performing a controlling process according to an inputting signal resulted from the key set 150. The key set 150 can be used for adjusting the sound volume. For example, the key set 150 can include a key labeled “+” or a key labeled “−”.

The BIOS circuit 160 is used for communicating with a plurality of hardware components during a turn on stage of the electronic device 100. When the electronic device 100 is turned on, the BIOS circuit 160 will initialize the chip set and the memory and check some important hardware components, such as a keyboard, a DVD ROM, an input/output port, and etc., to ensure the electronic device 100 can be initialized accurately and operated normally.

The audio connecter port 170 is used for connecting an audio media player 200 for inputting the audio signal S. The audio connecter port 170 can input the audio signal S without being provided with any power P. The audio connecter port 170 can be a 3.5 mm audio jack or a Sony-Philips Digital Interface Format (SPDIF) jack.

For saving the power consumption of the electronic device 100, an advanced configuration and power interface (ACPI) is used for controlling the power consumption of the electronic device 100. The ACPI has a S0 mode, a S1 mode, a S2 mode, a S3 mode, a S4 mode and a S5 mode.

During the S0 mode which is also called a power on mode, the OS and the application programs of the electronic device 100 are operated normally, and a center processing unit (CPU), a hard disk, an optical disk driver, and etc. are provided with the power P for normally operation.

During the S1 mode, the register of the CPU will be reset and stop performing commands. The memory and the CPU are provided with the power P, and the hardware components which are not used are not provided with the power P.

During the S2 mode, the memory is provided with the power P, and the CPU and the hardware components which are not used are not provided with the power P.

During the S3 mode, which is also called a sleep mode or a standby mode, the memory is provided with the power P, and the CPU and most hardware components are provided with the power P. The status of the OS and the application programs is stored in the memory, such that the electronic device 100 can be recovered to the status when leaves the S0 mode.

In the S4 mode, which is also called a Hibernation mode, the memory, the CPU and most hardware components are not provided with the power P, but the content of the memory is already stored in a non-volatile storage component, such as hard disk, such that the status of the OS and the application programs can be kept. After turning off the power, the electronic device 100 can be recovered to the status when the electronic device 100 leaves the S0 mode.

In the S5 mode, which is also called a power off mode, the CPU, the memory and most hardware components are not provided with the power P. Only a few hardware components used for waking up the electronic device 100 to the S0 mode, such as the keyboard controller 140, the clock, the modem and the network transmission component, are still be provided with the power P.

Generally speaking, the S1 mode, the S2 mode, the S3 mode and the S4 mode are called the power saving mode; the S5 mode is called the power off mode. The S3 mode, the S4 mode and the S5 mode are commonly used now.

In the present embodiment, the audio signal S can be received and processed by the audio codec 120, even if the electronic device 100 is under the power saving mode or the power off mode. Although the electronic device 100 is under the power saving mode or the power off mode, the user can input the audio signal S from the portable audio media player 200 and broadcast the audio signal S by the speaker 130 without waking up the electronic device 100.

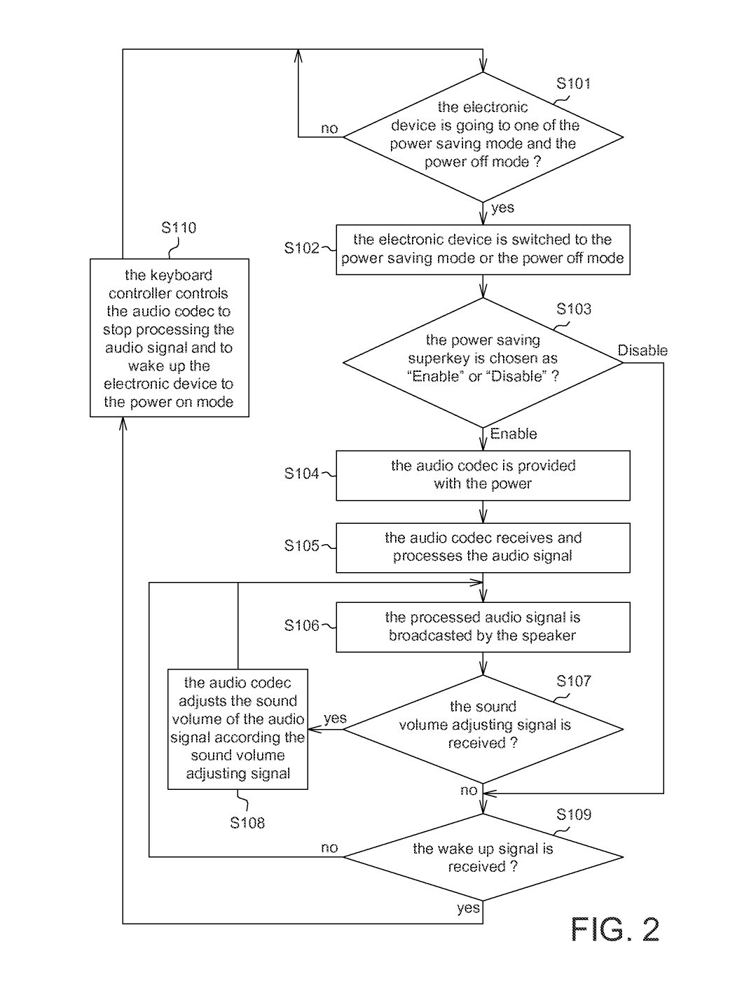

Please referring to FIG. 2, a flowchart of an audio broadcasting method is shown. FIG. 2 is illustrated by taking the electronic device 100 as an example.

In step S101, whether the electronic device 100 is going to one of the power saving mode and the power off mode is determined. If the electronic device 100 is going to one of the power saving mode and the power off mode, then the process proceeds to step S102; if the electronic device 100 is not going to one of the power saving mode and the power off mode, then the electronic device 100 it kept on the power on mode.

In S102, the electronic device 100 is switched to the power saving mode or the power off mode. For example, if the electronic device 100 is switched to the S3 mode, then the CPU and most hardware components are not provided with the power P, but the memory is kept being provided with the power P; if the electronic device 100 is switched to the S4 mode, then the content of the memory is stored in the non-volatile storage component, and the CPU, most hardware components and memory are not provided with the power P; if the electronic device 100 is switched to the S5 mode, then the CPU, the memory and almost all of the hardware components are not provided with the power P.

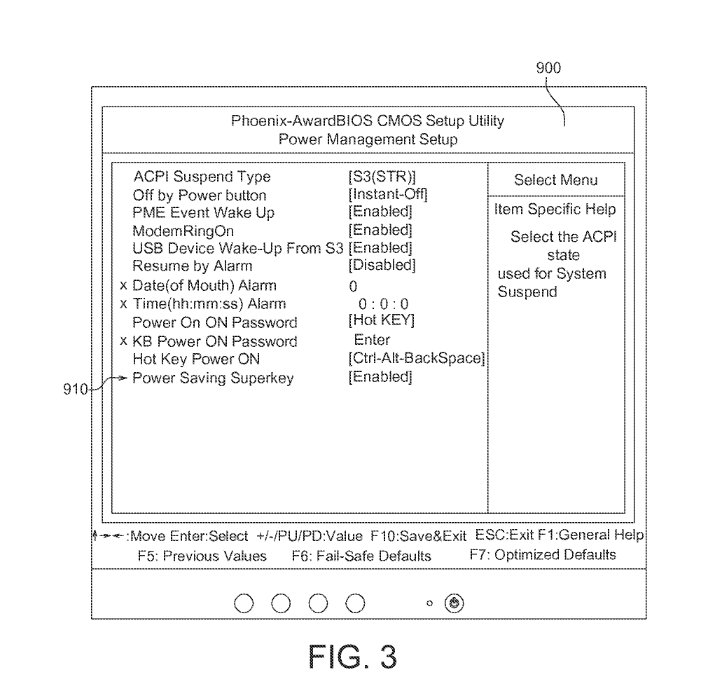

Please referring to FIG. 3, a BIOS setup menu 900 is shown. In the BIOS setup menu 900, a power saving superkey 910 has two choices, “Enabled” and “Disabled”.

In step S103, whether the power saving superkey 910 is chosen as “Enable” or “Disable” is determined. If the power saving superkey 910 is chosen as “Enable”, then the process proceeds to step S104; if the power saving superkey 910 is chosen as “Disable”, then the process proceeds to step S108.

In step S104, the audio codec 120 is provided with the power P. In this step, the power is provided form the power supply system 110 to the keyboard controller 140, and then the power P is provided from the keyboard controller 140 to the audio codec 120.

In general, under the power saving mode or the power off mode, the keyboard controller 140 is provided with the power P. In the present embodiment, a control right of the audio codec 120 belongs to the keyboard controller 140 and the audio codec 120 is provided with the power P from the keyboard controller 140 under the power saving mode or the power off mode, such that the audio codec 120 can receive or process the audio signal S under the power saving mode or the power off mode.

In step S105, the audio codec 140 receives and processes the audio signal S. The audio signal S can be provided from the audio connecter port 170. The content of the audio signal S can be stored in the portable audio media player 200, and transmitted to the audio codec 120 of the electronic device 100 through the audio connector port 170.

That is to say, although the hard disk of the electronic device 100 does not work under the power saving or the power off mode, the external audio signal S can be inputted through the audio connector port 170.

In step S106, the processed audio signal S is broadcasted by the speaker 130.

In step S107, whether a sound volume adjusting signal V is received is determined. If the sound volume adjusting signal V is received, then the process proceeds to step S108; if the sound volume adjusting signal V is not received, then the process proceeds to step S109.

In step S108, the audio codec 120 adjusts the sound volume of the audio signal S according the sound volume adjusting signal V. That is to say, the user can adjust the sound volume by the key set 150, under the power saving mode or the power off mode.

In step S109, whether a wake up signal W is received is determined. If the wake up signal W is received, then the process proceeds to step S110; if the wake up signal W is not received, then the process proceeds to step S106.

In step S110, the keyboard controller 140 controls the audio codec to stop processing the audio signal S and to wake up the electronic device 100 to the power on mode.

The electronic device 100 can be switched among the power on mode, the power saving mode and the power off mode. If the power saving superkey 910 of the BIOS setup menu 900 is chosen as “Enable”, the user can broadcast the audio signal S under the power saving mode or the power off mode. That is to say, the electronic device 100 can be used as a simple media player under the power saving mode or the power off mode. When the portable media player 200 does not equip with any horn or the power of the horn thereof is too low, the speaker 130 of the electronic device 100 can be effectively used.

Besides, because the power consumption under the power saving mode or the power off mode is less than that under the power on mode, broadcasting the audio signal S under the power saving mode or the power off mode economizes the power consumption of the electronic device 100.

The audio broadcasting method described above is not limited to the steps of the FIG. 2. For example, the steps S107 and S108 can be omitted optionally. The step S103 can be omitted optionally. The step S104 to S108 can be performed as a real-time process without sequence.

While the disclosure has been described by way of example and in terms of the exemplary embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio broadcasting method of an electronic device, comprising:
providing a power to an audio codec under a power saving mode or a power off mode;
receiving and processing an audio signal by the audio codec under the power saving mode or the power off mode; and
outputting the processed audio signal by a speaker under the power saving mode or the power off mode.

2. The audio broadcasting method of the electronic device according to claim 1, further comprising:
adjusting a sound volume of the audio signal according to a sound volume adjusting signal by the audio codec under the power saving mode or the power off mode.

3. The audio broadcasting method of the electronic device according to claim 1, further comprising:
stopping processing the audio signal and waking up the electronic device to a power on mode, if a wake up signal is received under the power saving mode or the power off mode.

4. The audio broadcasting method of the electronic device according to claim 1, wherein the power is provided to a keyboard controller (KBC) from a power supply system, and then the power is provided to the audio codec from the keyboard controller.

5. The audio broadcasting method of the electronic device according to claim 1, wherein a control right belongs to a keyboard controller under the power saving mode or the power off mode.

6. An electronic device, comprising:
a power supply system;
an audio codec, wherein a power is provided to the audio codec from the power supply system and the audio codec receives and processes an audio signal under a power saving mode or a power off mode; and
a speaker, for outputting the processed audio signal under the power saving mode or the power off mode.

7. The electronic device according to claim 6, further comprising:
a key set, for receiving a sound volume adjusting signal, wherein a sound volume of the audio signal is adjusted according to the sound volume adjusting signal under the power saving mode or the power off mode.

8. The electronic device according to claim 6, further comprising:
a keyboard controller (KBC), wherein the keyboard controller controls the audio codec to stop processing the audio signal and to wake up the electronic device to a power on mode, if a wake up signal is received under the power saving mode or the power off mode.

9. The electronic device according to claim 6, further comprising:
a keyboard controller, wherein the power is provided to a keyboard controller (KBC) from the power supply system, and then the power is provided to the audio codec from the keyboard controller.

10. The electronic device according to claim 6, further comprising:
a keyboard controller, wherein a control right belongs to the keyboard controller under the power saving mode or the power off mode.
